(19) United States
(12) Patent Application Publication
(10) Pub. No.: US 2020/0146944 A1
(43) Pub. Date: May 14, 2020

(54) DRESSING FOR ENTERAL AND VESICAL ACCESS DEVICES AND RELATED METHODS

(71) Applicant: THE REGENTS OF THE UNIVERSITY OF COLORADO, A BODY CORPORATE, Denver, CO (US)

(72) Inventors: Steven Lee Moulton, Denver, CO (US); Fergus Moynihan, Denver, CO (US); Jeremy Parsons, Denver, CO (US); Aleksander Stefanov, Denver, CO (US); Young Mee Choi, Denver, CO (US); Benjamin Fried, Denver, CO (US); Brian Heckman, Denver, CO (US); Tyler Mironuck, Denver, CO (US)

(73) Assignee: THE REGENTS OF THE UNIVERSITY OF COLORADO, A BODY CORPORATE, Denver, CO (US)

(21) Appl. No.: 16/608,158

(22) PCT Filed: Apr. 25, 2018
(86) PCT No.: PCT/US18/29434

§ 371 Date: Oct. 24, 2019

Related U.S. Application Data
(60) Provisional application No. 62/489,710, filed on Apr. 25, 2017.
(60) Provisional application No. 62/636,536, filed on Feb. 28, 2018.

(51) Int. Cl. A61J 15/00

(52) U.S. Cl. CPC A61J 15/0057

(57) ABSTRACT

The present disclosure comprises a multi-component dressing for securing an enteral access device, for example, a gastrosnootomy, jejunostomy, cecostomy or vesicostomy button or a gastrostomy tube, or a parenteral access device, and can comprise one or more of an adhesive layer, an absorptive layer and a securement layer to engage the device.

### FIELD

The present disclosure relates to enteral and vesical access devices, and more specifically to a multi-component dressing assembly and related methods.

### BACKGROUND

Certain individuals require feeding assistance due to swallowing disorders, issues gaining weight, poor hydration, or congenital anomalies within their digestive system. Others may require intermittent or continuous access to the urinary bladder for irrigation, decompression or drainage. A device that helps in the management of these unfavorable medical conditions is known as a gastrostomy tube (g-tube), gastrostomy button (g-button), gastrojejunostomy button (gj-button), jejunostomy device or button (j-button), enteral access device (EAD), or vesicostomy button. These devices allow food, fluids, nutritional supplements, and medications to be delivered directly into the stomach or small bowel. In other settings, such as anorectal anomalies or chronic constipation, these devices may be inserted into the cecum (proximal colon) to enable antegrade enemas. In still other settings these devices may be used for gastric, intestinal or bladder decompression. Regardless of their location in the intestinal tract, these devices are generally used at a minimum for several months, but in some cases are required for years or a patient's entire life.

Even though the placement of an enteral access device is a straightforward procedure, there are several bothersome postoperative complications that may arise. Most common are the formation of granulation tissue and leakage of gastric, intestinal or urinary contents around the device. These issues arise from a lack of securement between the device and the patient. The tube is free to rotate and move both laterally and vertically within the stoma. This movement exposes the button to external forces (clothes catching, accidental hand swipe, etc.) and human-related forces (twisting of the abdomen, skin folding, coughing, etc.), which can cause friction within the lumen of the stoma and on the surface of the skin. These forces can similarly lead to compression of the balloon of the device against the inner wall of the stomach, and shearing between the device and the patient's skin, which may widen the stoma. The current securement technique that doctors and nurses recommend is the “tic-tac-toe” taping method. This involves sliding a 2×2-inch gauze pad between the hub of the device and the patient's skin, in order to absorb leakage from the intestine, bladder or the tract itself. The dressing is then taped around the perimeter of the tube's entry hole to form a tic-tac-toe grid using tape (e.g., hypo-allergenic tape). Unfortunately, this method has not proven to be reliable or effective in stabilizing these devices.

### SUMMARY

In various embodiments, the present disclosure provides a multi-component dressing for securing an enteral or vesical access device, but which for simplicity may be called an enteral access device (EAD). The dressing may include an adhesive layer having a first surface for at least partially contacting a skin surface and a second surface opposing the first surface. The dressing may also include an absorptive layer (in some embodiments coupled to the first surface, in other embodiments disposed in a securement base and replaceable), a securement base coupled to the second surface for securing the hub of the enteral access device, and a perimetrically closed aperture defined in and extending through each of the adhesive layer, the absorptive layer and the securement base. The aperture may be configured so that the enteral access device can be accessed for feeding and the delivery of fluids and medications, while maintaining securement of the device.

In various embodiments, an outer perimeter of the absorptive layer is smaller than an outer perimeter of the adhesive layer. In various embodiments, an outer perimeter of the securement base is smaller than an outer perimeter of the adhesive layer. In various embodiments, a perimeter of the aperture remains substantially constant through each of the adhesive layer, the absorptive layer and the securement base. In various embodiments, the securement base includes a plurality of holes for receiving a lid of the enteral access device. In various embodiments, the adhesive layer absorbs and disperses forces applied to the enteral access device. The securement base may be rigid, semi-rigid or flexible, and the securement base may be configured to absorb and disperse forces applied to the enteral access device. In various embodiments, the securement base extends to the upper level of the hub. In various embodiments, the securement base provides three-dimensional stability to the hub of the enteral access device.

Also disclosed herein, according to various embodiments, is another implementation of a dressing for securing an enteral or vesical access device. The dressing may include an adhesive layer having a first surface for at least partially contacting a skin surface and a second surface opposing the first surface. The dressing may also include a lower base coupled to the adhesive layer, the lower base defining an opening and an absorbent member disposed in the opening of the lower base. The absorbent member may define an aperture through which at least a portion of the enteral access device is configured to extend. The dressing may further include an upper base detachably coupled to the lower base.

In various embodiments, the dressing further includes a lid coupled to the upper base. The lid may be detachably coupled to the upper base, or the lid may be integrally formed with the upper base. In various embodiments, the lid absorbs and disperses forces applied to the enteral access device. In various embodiments, the lower base absorbs and disperses forces applied to the enteral access device. In various embodiments, the upper base absorbs and disperses forces applied to the enteral access device. In various embodiments, in response to the lower base and the upper base being coupled to each other, the dressing provides three-dimensional stability to the enteral access device.

Also disclosed herein, according to various embodiments, is a method of using a dressing for securing an enteral or vesical access device. The method may include attaching a lower base to an adhesive layer, aligning an inner cutout of the adhesive layer and an opening defined by the lower base with a stoma, and positioning an absorbent member within a shape of the lower base around an enteral or vesical access device extending from the stoma.

The forgoing features and elements may be combined in various combinations without exclusivity, unless expressly indicated herein otherwise. These features and elements as well as the operation of the disclosed embodiments will become more apparent in the following description and accompanying drawings.

### BRIEF DESCRIPTION OF THE DRAWINGS

FIGS. 1A and 1B illustrate perspective and side views of an example dressing in accordance with the present disclosure;

FIG. 1C illustrates three-dimensional stability provided to an enteral or vesical access device in accordance with the present disclosure;

FIGS. 2A, 2B, 2C, 2D and 2E illustrate top, first side, bottom, perspective and second side views, respectively, of an example dressing having a saddle architecture in accordance with the present disclosure;

FIGS. 3A and 3B illustrate side and top views, respectively, of the example dressing of FIGS. 2A-2E, together with an enteral or vesical access device in accordance with the present disclosure;

FIGS. 4A, 4B, 4C, 4D and 4E illustrate top, first side, bottom, perspective and second side views, respectively, of an example dressing having a shield architecture in accordance with the present disclosure;

FIGS. 5A and 5B illustrate side and top views, respectively, of the example dressing of FIGS. 4A-4E, together with an enteral or vesical access device in accordance with the present disclosure;

FIGS. 6A and 6B illustrate top views of the example dressing of FIGS. 2A-2E, and related force distribution and limited displacement;

FIGS. 7A and 7B illustrate top views of the example dressing of FIGS. 4A-4E, and related force distribution and limited displacement;

FIGS. 8, 9, and 10 illustrate additional example dressings for securing enteral access devices in accordance with the present disclosure;

FIG. 11 illustrates a perspective view of an example dressing in accordance with the present disclosure;

FIG. 12 illustrates an exploded view of the components of the dressing in accordance with the present disclosure;

FIGS. 13A and 13B illustrate a lid being removed and a lid removed, respectively, from the dressing in accordance with the present disclosure;

FIG. 14 illustrates a perspective view of an absorbent member of the dressing being removed/replaced in accordance with the present disclosure;

FIGS. 15A and 15B illustrate views of a lower base and an upper base, respectively, of the dressing in accordance with the present disclosure;

FIGS. 16A and 16B illustrate views of an engagement between a lower base and an upper base, in accordance with an example embodiment of the present disclosure;

FIG. 17 illustrates a view of an upper base having a plurality of gripper arms, in accordance with an example embodiment of the present disclosure;

FIGS. 18A and 18B illustrate a bottom view and a top view of a lid of the dressing, in accordance with the present disclosure; and

FIGS. 19A and 19B illustrate views of a lid having an tab lock, in accordance with an example embodiment of the present disclosure.

The subject matter of the present disclosure is particularly pointed out and distinctly claimed in the concluding portion of the specification. A more complete understanding of the present disclosure, however, may best be obtained by referring to the detailed description and claims when considered with the drawing figures.

### DETAILED DESCRIPTION

The detailed description of exemplary embodiments herein refers to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

In accordance with example embodiments, the present disclosure comprises a dressing for securing an enteral access device. The dressing is intended to secure and protect the enteral access device, as well as mitigate the formation of granulation tissue and/or leakage of gastric, intestinal or bladder contents about the device, according to various embodiments. As used herein, an “enteral access device” or “EAD” can be a device such as a gastrostomy, jejunostomy, cecostomy or vesicostomy button or tube.

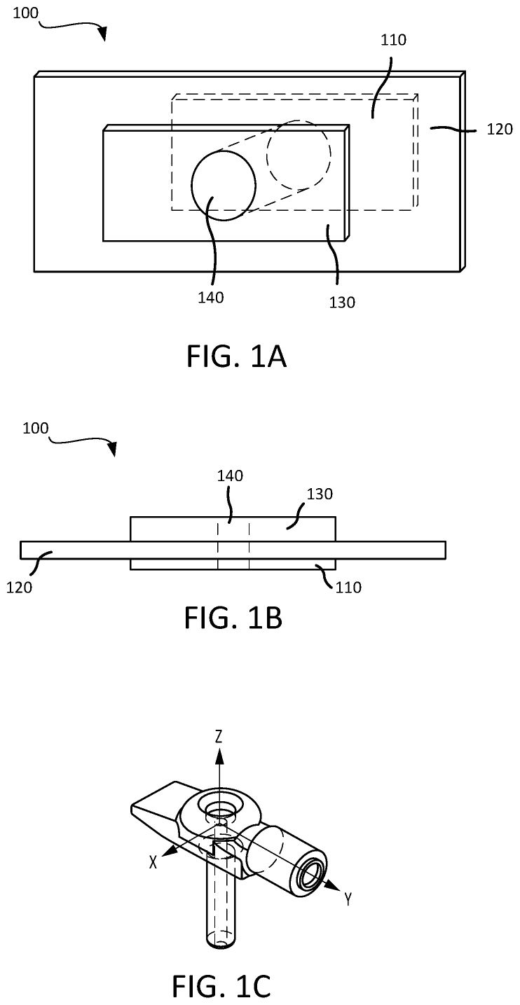

In general, and with reference to FIGS. 1A and 1B, a dressing 100 in accordance with the present disclosure can comprise one or more of an adhesive layer 120, an absorptive layer 110 and a securement base 130. In some embodiments, a single layer is comprised of a plurality of adhesive layer 120, absorptive layer 110 and securement base 130. By way of illustration, adhesive layer 120 and absorptive layer 110 may comprise the same layer, or otherwise be disposed in a common plane relative to one another (e.g., one layer surrounds another layer).

In example embodiments, adhesive layer 120 is configured to adhere a dressing of the present disclosure to a skin surface or other site where an enteral or vesical access device is prescribed. The adherence provided by adhesive layer 120 can be temporary (e.g., minutes, hours or days) or semi-permanent (e.g., days, weeks or months). By way of illustration, the adherence provided by adhesive layer 120 may last about 10-14, 7-10, 5-7 or 3-5 days. In some embodiments, adhesive layer 120 may be easily and atraumatically removable, so as to not cause pain or a significant rash or other irritation to the patient upon removal. Tape may be used to secure dressing 100 in lieu of an adhesive layer 120.

Adhesive layer 120 comprises a first surface and a second surface opposing the first surface. In example embodiments, the first surface is at least partially in contact with a skin surface. In example embodiments, the first surface is in total contact with a skin surface. The outer perimeter of adhesive layer 120 can be elliptical (e.g., circles, ovals, ellipses, and the like), non-elliptical (e.g., triangles, rectangles, squares, hexagons, trapezoids, pentagons, stars, and the like), or random (e.g., cut by stamping, knife CNC, waterjet or laser). In example embodiments, adhesive layer 120 is flexible so as to conform to a skin surface or other site where an enteral or vesical access device is prescribed.

Adhesive layer 120 can be comprised of a fabric or polymeric film with an adhesive bottom. Suitable materials for the adhesive layer 120 include, but are not limited to silicone or silicone-free adhesives with non-woven, woven, acrylic, or polyurethane backings that are biocompatible. In an example embodiment, the second surface of adhesive layer 120 does not comprise any backing, but rather, comprises an adhesive (e.g., acrylic) to attach securement base 130.

In example embodiments, absorptive layer 110 is configured to absorb blood, plasma and/or gastric, intestinal or bladder exudates, and thereby reduce skin irritation. By minimizing the presence of these biological irritants, the absorbent layer may promote cleanliness at a stoma and reduced stoma-related complications at the site where an enteral access device is prescribed.

Absorptive layer 110 in accordance with the present disclosure can be matched or unmatched to the first surface of adhesive layer 120. In example embodiments, the outer perimeter of absorptive layer 110 is smaller than the outer perimeter of adhesive layer 120. Like adhesive layer 120, the outer perimeter of absorptive layer 110 can be elliptical, non-elliptical or random (e.g., cut by stamping, knife CNC, waterjet or laser). Also like adhesive layer 120, in example embodiments, absorptive layer 110 is flexible so as to conform to a stoma or other site where an enteral access device is prescribed.

In example embodiments, absorptive layer 110 is at least partially in contact with a stoma and a surrounding skin surface. In example embodiments, absorptive layer 110 is in total contact with a stoma and a surrounding skin surface. In this regard, in example embodiments, absorptive layer 110 and adhesive layer 120 are both in contact with a skin surface at the same time.

In still other embodiments, a film or other covering may partially enclose absorptive layer 110 such that only the edge(s) in contact with a stoma or wound site are open for absorbing blood, plasma and/or gastric, intestinal or bladder exudates, for example, an edge of absorptive layer 110 that perimetrically surrounds a stoma or wound site. In some embodiments, clearance is minimized between an EAD stem and an edge of absorptive layer 110 that perimetrically surrounds the stem of the device.

Suitable materials for absorptive layer 110 include, but are not limited to cotton gauze or other natural or man-made absorbent or wicking material that is one or more of hydroconductive, non-adherent, anti-bacterial, anti-fungal and biocompatible. Absorptive layer can have a thickness of from about 0.5 to about 6 mm or more preferably, from about 1 to about 3 mm.

Securement base 130 in accordance with the present disclosure can be configured to secure an enteral access device (e.g., a hub of an enteral access device). That is, in example embodiments, and with momentary reference to FIG. 1C, securement base 130 is configured to provide one, two or three-dimensional stability (i.e., limit displacement in the x and/or y and/or z directions) to an enteral access device. In some embodiments, securement base 130 is configured to prevent rotational movement of an enteral access device.

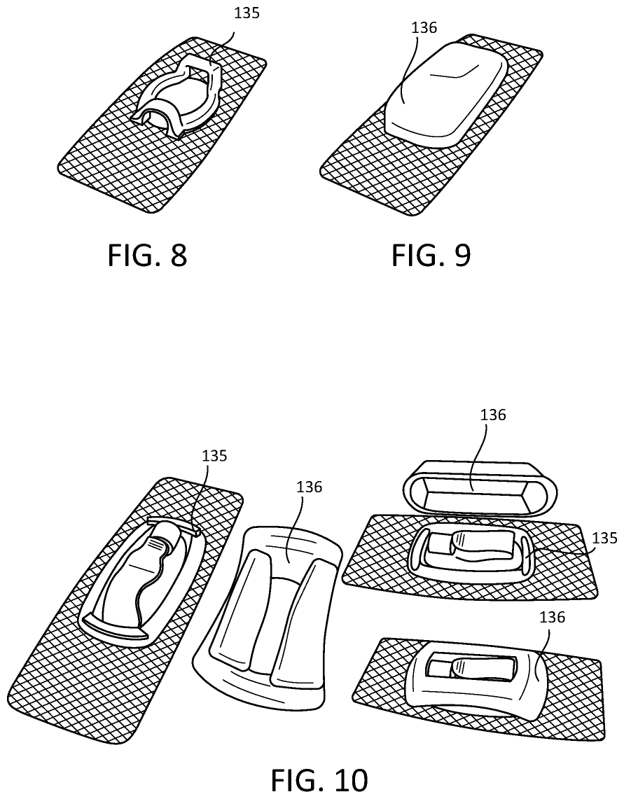

In some embodiments, securement base 130 being configured to prevent movement of an enteral access device in the z direction may prevent a balloon or other portion of an enteral access device from migrating into the tract of a stoma or other site where the device is prescribed. For example, and with momentary reference to FIGS. 8, 9, and 10, a flange, edge, or other such structure 135 of securement base 130 may serve to secure a portion of an EAD against, or otherwise apply pressure on a portion of an EAD toward, the surface of the skin. In still other embodiments, and with momentary reference to FIGS. 8, 9, and 10, securement base 130 can be configured to include a covering 136 that shields an enteral access device from external forces, for example, by partially or completely covering an enteral access device. In various embodiments, the covering 136 may engage a flange, edge, or other structure 135 of securement base 130. In such embodiments, securement base 130 may not provide any access to an underlying enteral access device. In other words, to gain access to an underlying enteral access device, some embodiments may require removal of dressing 100.

Securement base 130 in accordance with the present disclosure can be coupled to the second surface of adhesive layer 120. In example embodiments, the outer perimeter of securement base 130 is smaller than the outer perimeter of adhesive layer 120. Like adhesive layer 120 and absorptive layer 110, the outer perimeter of securement base 130 can be elliptical, non-elliptical or random.

In some embodiments, securement base 130 comprises one or a plurality of holes for receiving a lid of an enteral access device (e.g., to secure a lid during a feeding process). In alternative embodiments, securement base 130 extends below, to or above the upper level of an enteral access device (e.g., the hub of an enteral access device).

In some embodiments, securement base 130 is rigid or semi-rigid, while in other embodiments, securement base 130 is flexible. Rigid and semi-rigid materials can include acrylonitrile butadiene styrene (ABS), nylon, a co-polymer, thermoplastic or other polymer, polycarbonate, or the like, while flexible materials can include open cell foam, silicone foam, polyethylene foam, or the like. In example embodiments, such materials are biocompatible.

With continued reference to FIGS. 1A and 1B, a dressing 100 for securing an enteral access device in accordance with the present disclosure comprises an aperture 140. In accordance with example embodiments, aperture 140 is configured so that the enteral access device can be accessed for feeding and the delivery of fluids and medications, while maintaining securement of the enteral access device. In example embodiments, aperture 140 is perimetrically closed. That is, dressing 100 can be devoid of any slits. In example embodiments, aperture 140 extends through each of adhesive layer 120, absorptive layer 110 and securement base 130. Aperture 140 can conform (or substantially conform) to the dimensions of an enteral access device in connection with which dressing 100 is being used. In example embodiments, the perimeter of aperture 140 remains substantially constant through each of the absorptive layer 110 and securement base 130. In other embodiments, the perimeter of aperture 140 is not constant through each of the absorptive layer 110 and securement base 130. By way of example, the perimeter of aperture 140 at absorptive layer 110 may be greater than the perimeter of aperture 140 at securement base 130. In another example, the perimeter of aperture 140 may taper between absorptive layer 110 and securement base 130 to form a frustoconical aperture. In general, various embodiments may provide more clearance near a stoma or other site where an enteral access device is prescribed, while also providing a snug fit at the enteral access device.

Illustrative examples of enteral access devices in accordance with the present disclosure will now be described.

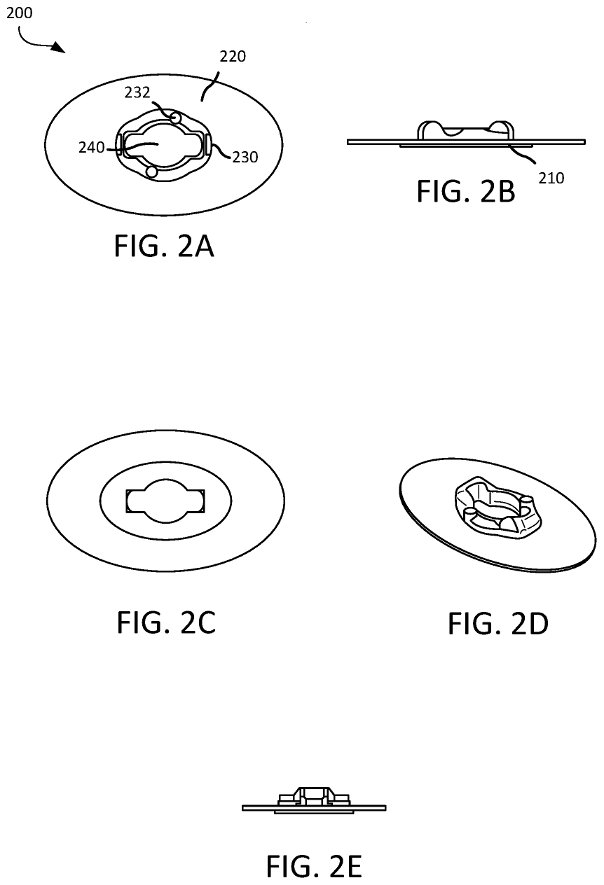

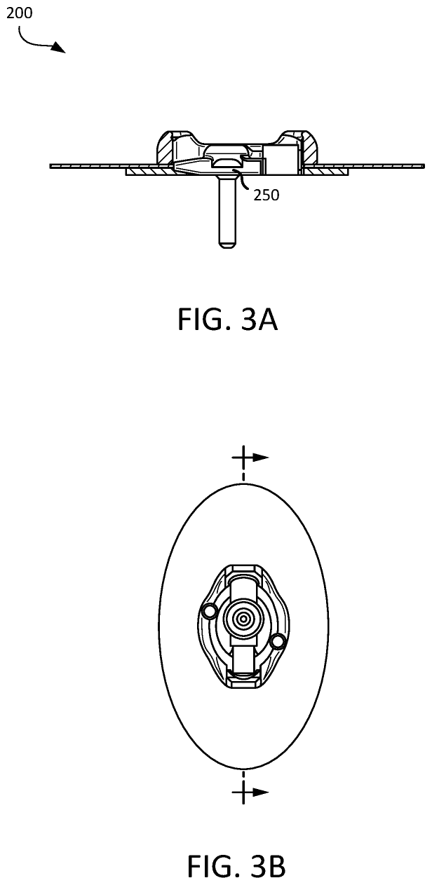

FIGS. 2A, 2B, 2C, 2D and 2E illustrate top, first side, bottom, perspective and second side views, respectively, of an example dressing 200 having a saddle architecture in accordance with the present disclosure. This illustrated embodiment may be particularly useful in connection with an AMT MiniONE® Button (Applied Medical Technology, Inc., Brecksville, Ohio) or MIC-KEY* Low-Profile enteral access device (Halyard Health, Alpharetta, Ga.). More generally, a saddle architecture may be useful in permitting rotation of a feeding tube connector that is inserted into the enteral access device. An adhesive layer 220 comprises a first surface and a second surface opposing the first surface. An absorptive layer 210 is coupled to the first surface and a securement base 230 is coupled to the second surface. An aperture 240 extends through each of adhesive layer 220, absorptive layer 210 and securement base 230. Securement base 230 comprises a plurality of holes 232 for receiving the removeable cap or lid of an enteral access device 250, as illustrated in FIGS. 3A and 3B, which depict side and top views, respectively, of dressing 200, together with gastrostomy button 250 in accordance with the present disclosure.

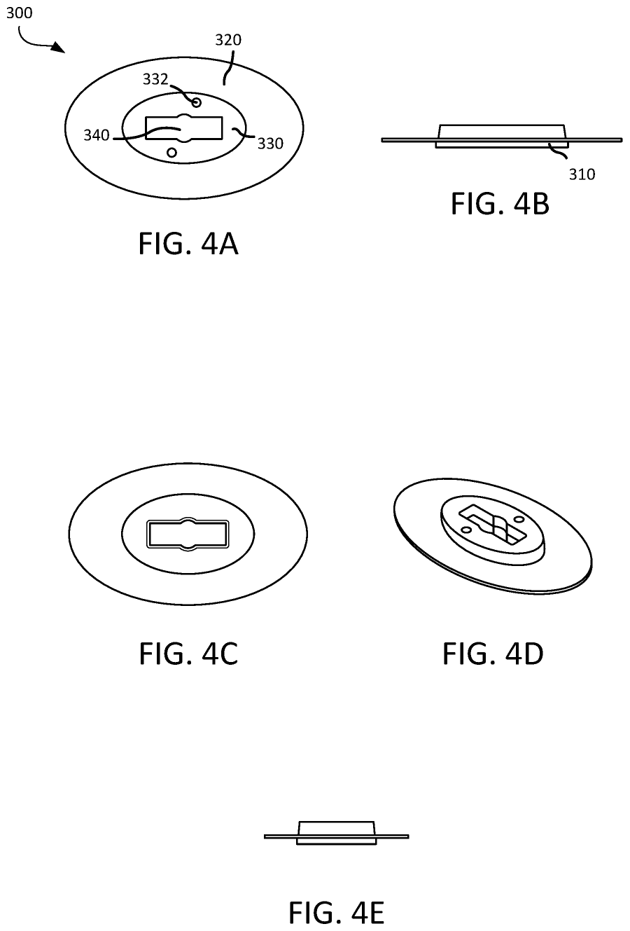

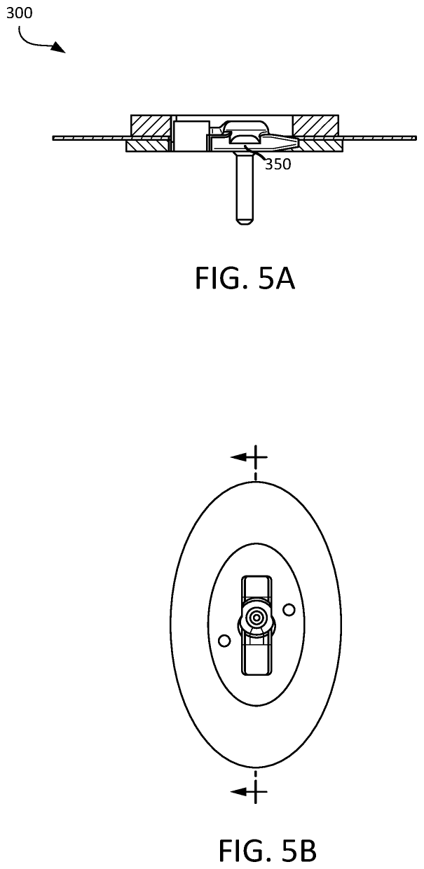

Turning now to FIGS. 4A, 4B, 4C, 4D and 4E, illustrated are top, first side, bottom, perspective and second side views, respectively, of an example dressing 300 having a shield architecture in accordance with the present disclosure. In this illustrated embodiment, securement base 330 shields an enteral access device from external forces by extending to or slightly above the upper level of the hub of the enteral access device. An adhesive layer 320 comprises a first surface and a second surface opposing the first surface. An absorptive layer 310 is coupled to the first surface and a securement base 330 is coupled to the second surface. An aperture 340 extends through each of adhesive layer 320, absorptive layer 310 and securement base 330. Securement base 330 comprises a plurality of holes 332 for receiving the removeable cap or lid of an enteral access device 350, as illustrated in FIGS. 5A and 5B, which depict side and top views, respectively, of dressing 300, together with an enteral access device 350 in accordance with the present disclosure.

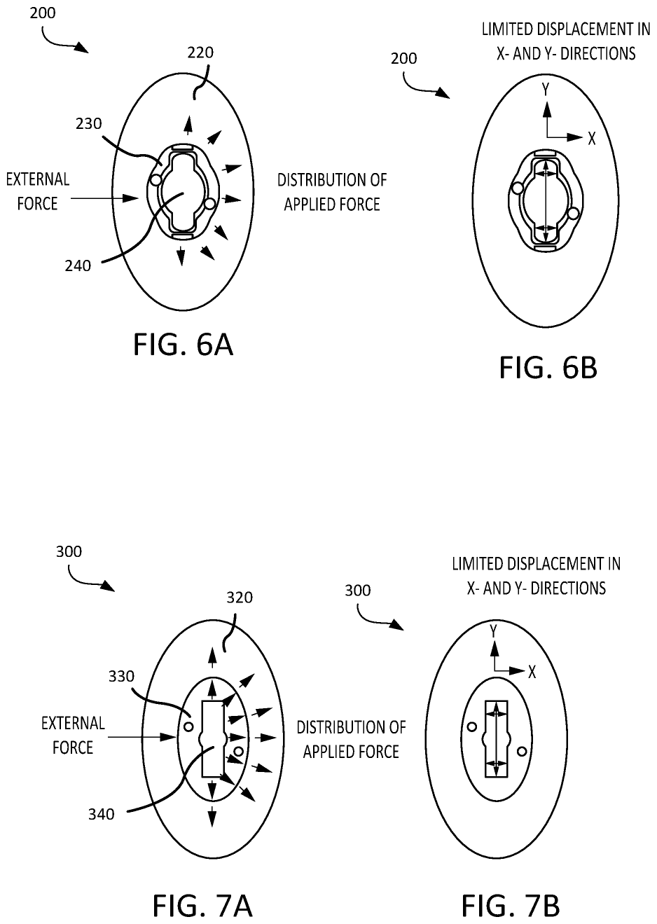

A dressing for securing an enteral access device in accordance with the present disclosure absorbs and disperses forces applied to the enteral access device, for example, over a larger surface area. As used herein, “forces” can refer to external forces (clothes catching, accidental hand swipe, etc.) and/or human-related forces (twisting of the abdomen, skin folding, coughing, etc.). In some embodiments, and with reference to FIG. 6A, an adhesive layer 220 (and in some embodiments, a securement base 230) provides these benefits. In other embodiments, and with reference to FIG. 7A, an adhesive layer 320 and a securement base 330 both contribute to absorbing and dispersing forces applied to the enteral access device. In example embodiments, the base of an example dressing may allow for approximately one quarter of an inch of clearance around the stoma in an effort to reduce pressure near the wound site. This clearance may also make it easier to clean the stoma and the surrounding area.

As mentioned above, a securement base may also provide one, two or three-dimensional stability (i.e., limit displacement in the x and/or y and/or z directions) to an enteral access device. By way of example, FIG. 6B depicts this limited displacement with respect to dressing 200 having a saddle architecture, and FIG. 7B depicts this limited displacement with respect to dressing 300 having a foam or shield architecture.

An experiment was conducted to measure the relative displacement of a gastrostomy button when used in connection with various dressings within the scope of the present disclosure. In contrast to no dressing or a tic-tac-toe dressing, which respectively exhibited about 1.0 and about 0.4 normalized units of relative displacement in response to a 2 N force applied externally, dressings within the scope of the present disclosure exhibited less than about 0.05 normalized units of relative displacement.

Methods of using and manufacturing the dressing described above are also within the scope of the present disclosure.

As a non-limiting example, the following steps may be used to manufacture an example dressing 200 having a saddle architecture: (i) align the inner cutout of the absorptive layer with the fixture; (ii) place absorptive layer into the fixture cavity; (iii) peel circular-shaped backing off the adhesive layer; (iv) with the fabric side facing up, align the inner cutout of the adhesive layer with the fixture; (v) place the adhesive layer on top of the absorptive layer; (vi) press and rub the adhesive layer against the absorptive layer to ensure the adhesive makes uniform contact with the absorptive material; (vii) fully coat the bottom surface of the saddle structure with a thin layer of glue; (viii) with the glue covered surface of the saddle facing down, align the inner profile of the saddle with the fixture; (ix) press the saddle structure against the adhesive layer to ensure the glue makes uniform contact with the fabric material of the adhesive layer; (x) apply pressure for about several minutes to help with the bonding of the glue; (xi) inspect the edges of the saddle to ensure it is fully adhered to the adhesive layer (if there is separation between layers, reapply glue to those areas and apply pressure); and (xii) remove the fully assembled dressing from the fixture and repeat the process. The foregoing steps may be automated and may comprise 3D printing, injection molding, polymer casting and/or machining.

Similarly, the following steps may be used to manufacture an example dressing 300 having a shield architecture: (i) align the inner cutout of the absorptive layer with the fixture; (ii) place absorptive layer into the fixture cavity; (iii) peel circular-shaped backing off the adhesive layer; (iv) with the fabric side facing up, align the inner cutout of the adhesive layer with the fixture; (v) place adhesive layer on top of absorptive layer; (vi) press and rub the adhesive layer against the absorptive layer to ensure adhesive makes uniform contact with absorptive material; (vii) peel backing off the foam structures; (viii) with the adhesive side of the foam facing down, align the inner cutout of the foam with the fixture; (ix) press and rub the foam against the adhesive layer to ensure adhesive from the foam makes uniform contact with fabric material of the adhesive layer; and (x) remove fully assembled dressing from the fixture and repeat. The foregoing steps may be automated and may comprise stamping, knife CNC, waterjet or laser cut out profiles from sheets of material, injection molding and/or polymer casting.

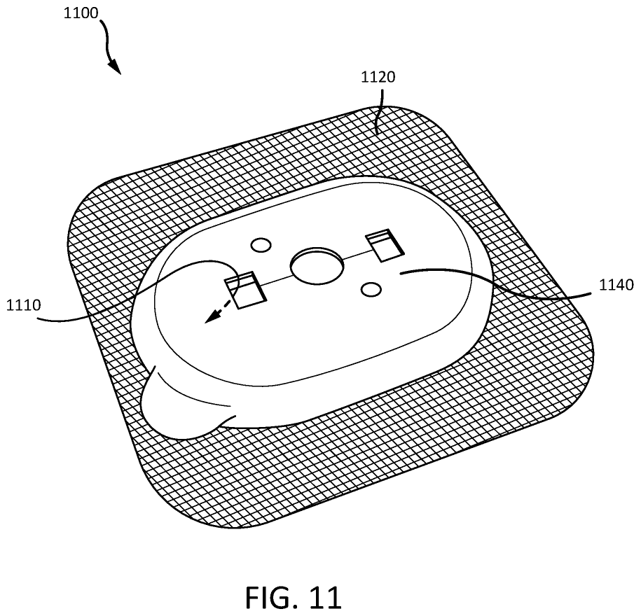

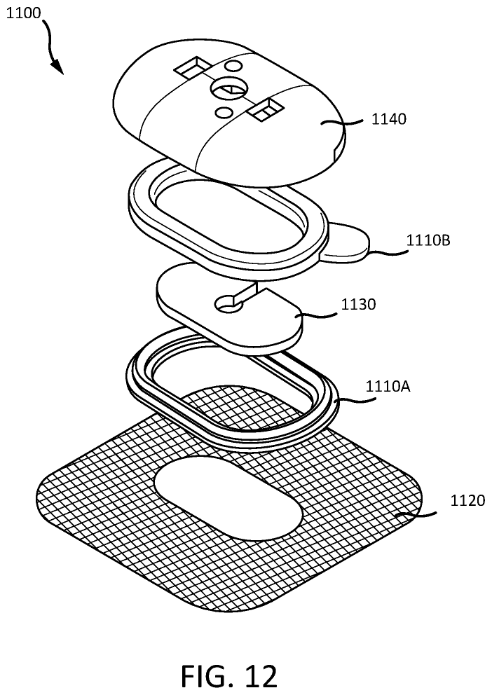

With reference now to FIG. 11, a multi-component dressing 1100 in accordance with the present disclosure may incorporate design elements of the saddle and foam dressings described above, including but not limited to a base 1110 (e.g., 1110A/1110B as shown in FIGS. 12, 13A, 13B, 14, 15A, and 15B), which may be similar to base 130 described above, and an adhesive layer 1120, which may be similar to adhesive layer 120 described above. Generally, the dressing 1100, which may be similar to and may include features similar to the embodiments of the dressing 100, 200, 300 provided above, is configured to secure an enteral access device (e.g., a hub of an enteral access device) and/or is configured to provide a removable covering/lid 1140, which may be similar to the covering 136 described above, to help stabilize and secure the enteral access device. For example, the dressing 1100, including the base 1110, may be configured to provide one, two or three-dimensional stability (i.e., limit displacement in the x and/or y and/or z directions) to an enteral access device. In some embodiments, the base 1110 may include a lower base 1110A and an upper base 1110B (see FIG. 12) that are detachably coupled together. The lower base 1110A and the upper base 1110B, together with a lid 1140, may facilitate retaining an absorbent member 1130 (see FIG. 12), which may be similar to absorptive layer 110 described above, in place and/or may facilitate replacement of the absorbent member 1130, as described in additional detail below.

In various embodiments, and with reference to FIG. 12, the adhesive layer 1120 is configured to adhere the dressing 1100 to a skin surface or other site where an enteral access device is prescribed. The adherence provided by the adhesive layer 1120 can be temporary (e.g., minutes, hours or days) or semi-permanent (e.g., days, weeks or months). By way of illustration, the adherence provided by adhesive layer 120 may last about 10-14, 7-10, 5-7 or 3-5 days. In some embodiments, the adhesive layer 1120 may be easily and atraumatically removable, so as to not cause pain or a significant rash or other irritation to the patient upon removal.

The adhesive layer 1120 may be made from a non-woven, breathable mesh material. This material may be laser cut. The adhesive layer 1120 may be made with silicone (e.g., having a thickness of about 0.25 mm) or silicone-free adhesives with non-woven, woven, acrylic, or polyurethane backings that are biocompatible. In an example embodiment, the second surface of adhesive layer 1120 does not comprise any backing, but rather, comprises an adhesive (e.g., acrylic) to attach securement base 130.

The shape of adhesive layer 1120 may be such to allow the dressing/device 1100 to best adhere around curved surfaces without any “tenting” or premature peeling. For example, the corners of adhesive layer 1120 may be rounded to prevent “tenting” or premature peeling.

The adhesive layer 1120 may have a first surface and a second surface opposing the first surface. In example embodiments, the first surface is configured to face and engage a skin surface of a user/patient. In example embodiments, the first surface is in total contact with a skin surface. The outer perimeter of adhesive layer 1120 can be elliptical (e.g., circles, ovals, ellipses, and the like), non-elliptical (e.g., triangles, rectangles, squares, hexagons, trapezoids, pentagons, stars), or the like. In example embodiments, the adhesive layer 1120 is flexible so as to conform to a skin surface or other site where an enteral access device is prescribed.

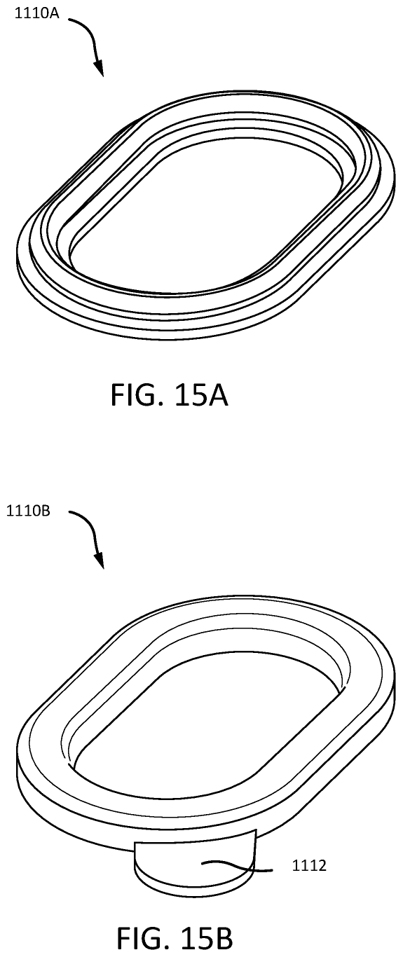

In various embodiments, and with reference to FIGS. 12, 15A, and 15B, the base 1110 may include a lower base 1110A coupled to the adhesive layer 1120 and an upper base 1110B that is detachably coupleable to the lower base 1110A. For example, the lower base 1110A may be glued or otherwise bonded to the adhesive layer 1120. Coupling through magnetism or hook and loop fasteners is also contemplated, among other coupling designs. The portions 1110A, 1110B of the base 1110 may be made from a rigid or semi-rigid or resiliently flexible material. The base 1110 may define a border of an opening, and the dressing 1100 may be situated relative to the skin of the patient such that the opening is positioned around the stoma. In various embodiments, an absorbent member 1130 may be disposed with the opening defined by the base 1110. In various embodiments, the upper base 1110B may be configured to retain the absorbent member 130 in place in response to the upper base 1110B being coupled to the lower base 1110A. Accordingly, a user may detach the lower base 1110A from the upper base 1110B and the cover 1140 to allow the absorbent member 1130, which is disposed around the stoma and around a tube or port of an enteral access device, to be removed and/or replaced. Accordingly, the upper and lower base portions 1110A, 1110B may have a snap ring structure. Moreover, the lower base 1110A may include an inward projecting flange to contact, align and stabilize the EAD when the user is coupling 1110B to 1110A.

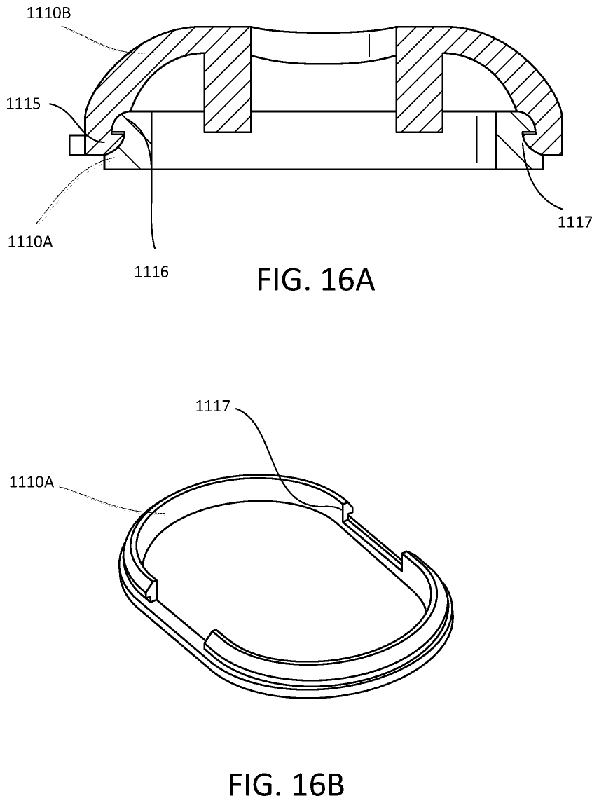

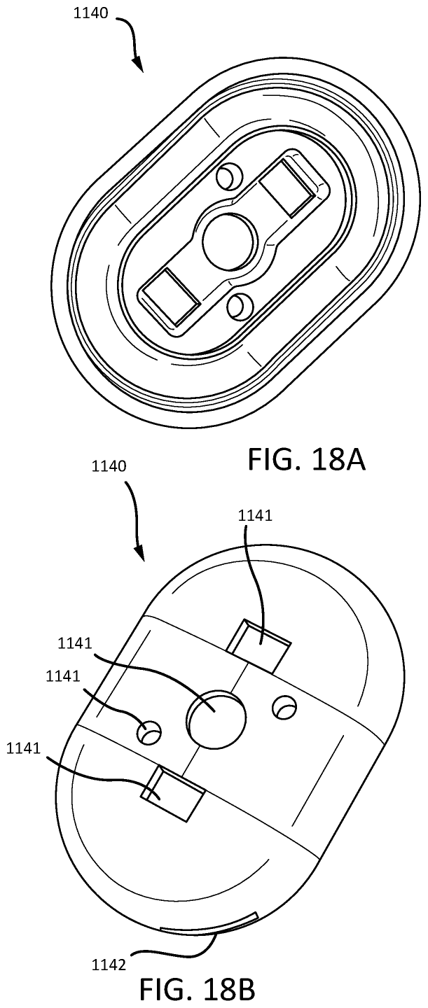

For example, and with reference to FIG. 16A, the lower base 1110A may include a male engagement structure 1116 and the upper base 1110B may include a female engagement structure 1115, or vice-versa, such that the upper base 1110B is detachably coupled to the lower base 1110A at an engagement 1117. In some embodiments, engagement 1117 is circumferential, about the perimeters of the lower base 1110A and the upper base 1110B. In other embodiments, however, and with reference to FIG. 16B, engagement 1117 is not circumferential, but instead, comprises a 180-degree connection on each side of base 1110. Stated another way, engagement 1117 can be discontinuous about the perimeters of the lower base 1110A and the upper base 1110B. In this regard, a rim of a male engagement structure 1116 and/or a female engagement structure 1115 may be discontinuous. Such embodiments may provide for increased flexibility over a patient's skin surface.

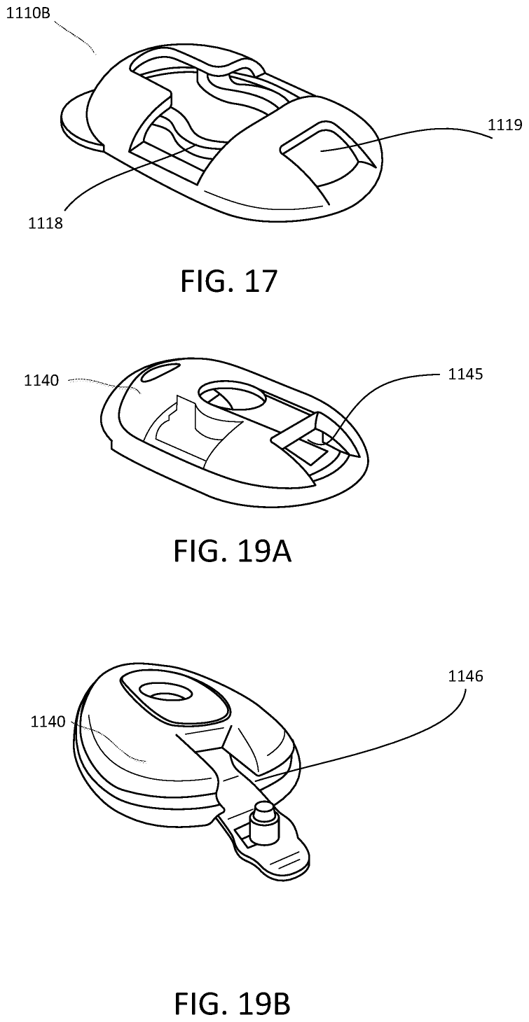

In some embodiments, and with reference to FIG. 17, the upper base 1110B can further comprise a gripper arm 1118 on one or both sides of base 1110. Gripper arm 1118 (or a plurality of gripper arms 1118) can extend from an inner surface of the upper base 1110B. Gripper arm 1118 can be coupled to an inner surface of the upper base 1110B at ends of gripper arm 1118. In some embodiment, gripper arm 1118 comprises a concave portion between ends of gripper arm 1118, to conform to an outer dimension of a portion of an EAD in contact with gripper arm 1118. Gripper arm 1118 can comprises a resilient material, capable of elastic deformation under stress applied to gripper arm 1118 to secure an EAD. Gripper arm 1118 (or a plurality of gripper arms 1118) can provide for increased stability during manipulation of an EAD without translating forces associated with such manipulation to a patient's skin surface or the stoma track. Such stability may have particular utility when attaching or detaching the extension tubing that connects to the EAD. The upper base 1110B can further comprise a base tab opening 1119 for receiving a tab of an EAD, discussed in greater detail below.

In some embodiments, the base 1110 is rigid or semi-rigid, while in other embodiments, base 1110 is flexible. Rigid materials can include acrylonitrile butadiene styrene (ABS), nylon, a co-polymer, thermoplastic or other polymer, polycarbonate, or the like, while flexible materials can include open cell foam, silicone foam, polyethylene foam, or the like. In example embodiments, such materials are biocompatible. In various embodiments, and with reference to FIG. 15B, the upper base 1110B may include a tab that enables a user to easily grasp and detach the upper base 1110B from the lower base 1110A.

In various embodiments, and with reference to FIGS. 12 and 14, absorbent member 1130 is configured to absorb blood, plasma and/or gastric, intestinal, urine or urinary bladder exudates, thereby reducing skin irritation. By minimizing the presence of these biological irritants, the absorbent layer may promote cleanliness and reduce wound complications at a stoma or other site where an enteral access device is prescribed. In example embodiments, the outer perimeter of the absorbent member 1130 is smaller than the perimeter of the opening defined by the base 1110 and smaller than the perimeter of the adhesive layer 1120. Like adhesive layer 1120, the outer perimeter of the absorbent member 1130 may be elliptical, non-elliptical, or may have another shape. Also like adhesive layer 1120, in example embodiments, absorbent member 1130 is flexible so as to conform to a stoma or other site where an enteral access device is prescribed. In some embodiments, clearance is minimized between an EAD stem and an edge of absorbent member 1130 that perimetrically surrounds the EAD stem.

In example embodiments, absorbent member 1130 is at least partially in contact with a stoma and a surrounding skin surface. For example, adhesive layer 1120 may have an opening similar in size and shape to the opening defined by the base 1110. In example embodiments, absorbent member 1130 is in contact with a stoma and surrounding skin surface. In this regard, in example embodiments, absorbent member 1130 and adhesive layer 1120 are both in contact with a skin surface at the same time. Suitable materials for absorbent member 1130 include, but are not limited to, cotton gauze or another natural or man-made absorbent or wicking material that is one or more of hydroconductive, non-adherent, anti-bacterial, anti-fungal, environmentally friendly (e.g., non-toxic), and biocompatible.

In various embodiments, and with reference to FIGS. 12, 18A, and 18B, the dressing 1100 may include a lid 1140. Lid 1140 may be a cover that extends across the opening defined by the base 1110. In various embodiments, the lid 1140 is made from a silicone material. The hardness rating of the lid 1140 may be Shore 10A (e.g., substantially equivalent to that of a rubber band). Accordingly, the lid 1140 may be soft enough to conform to the patient's skin and to absorb minor external forces. It is also durable enough to create a protective shell and casing around the enteral access device and prevent any large movements by protecting the EAD from impulses and impacts.

As shown in FIGS. 18A and 18B, the lid 1140 may include one or more apertures 1141 through which portions of the enteral access device are configured to extend to facilitate retention of such portions of the enteral access device. In various embodiments, the lid 1140 may be spaced a distance away from the G-button such that if an impact contacts the outer silicone lid 1140, there is approximately 2-5 mm of space in the rectangular region that will protect the G-Button from significant movement.

In some embodiments, and with reference to FIG. 19A, the lid 1140 further comprises a lid tab opening 1145 corresponding to the base tab opening 1119 discussed above. Similar to the base tab opening 1119, the lid tab opening 1145 can be configured to receive a tab of an EAD.

For example, and with reference to FIGS. 19A and 19B, the lid tab opening 1145 can be configured with a tab lock to lock the tab of an EAD in place while the EAD is being used. In this regard, the lid tab opening 1145 can comprises an inner edge 1146 having a smaller inner dimension than an outer dimension of the tab of an EAD, so as to secure such tab beneath the inner edge 1146.

The upper base 1110B and the lid 1140 may be separable components. For example, the lid 1140 may include a slit 1142 through which the tab 1112 of the upper base 1110B (FIG. 15B) is configured to extend. In various embodiments, while the upper base 1110B and the lid 1140 may be separate components, they may be substantially permanently affixed together upon assembling the dressing 1100. For example, the lid 1140 may be mechanically fastened or chemically bonded to the upper base 1110B. In various embodiments, the upper base 1110B and the lid 1140 are formed of a unitary, monolithic structure. In addition, with reference to FIG. 18A, when the outer margins of the lid 1140 are compressed, the internal dimensions of the lid come intact with and stabilize the enteral access device 150, to facilitate attaching and detaching the extension feeding tube to the EAD.

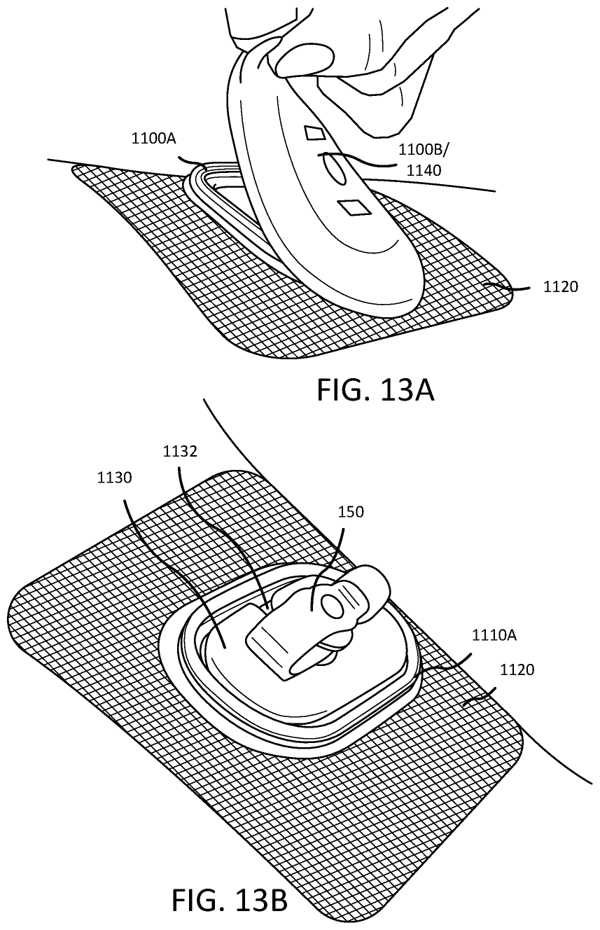

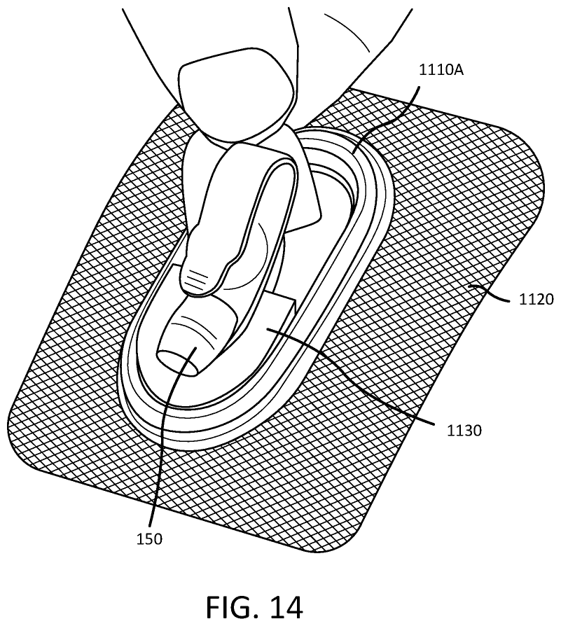

In various embodiments, and with reference to FIGS. 13A, 13B, and 14, a process of replacing the absorbent member 1130 is depicted. In FIG. 13A, upper base 1110B and the lid 1140 are detached from engagement with the lower base 1110A. As shown in FIG. 13B, the absorbent member 1130 may be housed underneath the now removed lid 1140 and may be disposed around the enteral access device 150. The absorbent member 1130 may have a slit 1132 that enables the absorbent member 1130 to be replaced with a new one without removing or excessively disturbing the enteral access device 150. That is, the slit 1132 enables a user to install and remove the absorbent member 1130, which has a ring like shape that may complement the shape of the opening defined by the base 1110. Slit 1132 includes a cutout in the middle of the absorbent layer to fit around the stem of the enteral access device 150, which enables the absorbent member 1130 to be placed in close proximity to the stoma (e.g., positioned with less than a 3 millimeter gap between the absorbent member 1130 and the stoma), thereby facilitating absorption of fluid from the stoma. Accordingly, FIG. 14 shows a used/spent absorbent member 1130 being removed or a new absorbent member 1130 being installed.

Methods of using and manufacturing the dressing described above are also within the scope of the present disclosure. As a non-limiting example, the following steps may be employed to use the dressing 1100. (i) attach a lower base 1110A to the adhesive layer 1120, (ii) align an inner cutout of the adhesive layer 1120 and the opening defined by the lower base 1110A with a stoma, (iii) peel backing off the adhesive layer 1120; (iv) press and rub the adhesive layer 1120 against the skin of the patient around the stoma, (v) position the absorbent member 1130 around the stem of an enteral access device that is inserted relative to the stoma, and (vi) cover the opening in the base layer with a lid 1140 by coupling the upper base 1110B to the lower base 1110A.

It will be apparent to those skilled in the art that various modifications and variations can be made in the present disclosure without departing from the spirit or scope of the disclosure. For example, while various embodiments have been described with reference to a dressing for a gastrostomy button, the invention is not so limited, and may be applied more generally to dressings for other enteral, vesical and parenteral access devices. Thus, it is intended that the embodiments described herein cover the modifications and variations of this disclosure provided they come within the scope of the appended claims and their equivalents.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Also, any reference to attached, fixed, connected, coupled or the like may include permanent (e.g., integral), removable, temporary, partial, full, and/or any other possible attachment option. Different cross-hatching is used throughout the figures to denote different parts but not necessarily to denote the same or different materials.

The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Any reference to attached, fixed, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts or areas but not necessarily to denote the same or different materials. In some cases, reference coordinates may be specific to each figure.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A multi-component dressing for securing an enteral or vesical access device comprising:
an adhesive layer having a first surface for at least partially contacting a skin surface and a second surface opposing the first surface;
an absorptive layer;
a securement base coupled to the second surface for securing a hub of the enteral or vesical access device;
a perimetrically closed aperture defined in and extending through each of the adhesive layer, the absorptive layer and the securement base, wherein the aperture is configured so that the enteral access device can be accessed for feeding, decompression and/or delivery of fluids and medications, while maintaining securement of the enteral access device.

2. The dressing of claim 1, wherein a perimeter of the aperture remains substantially constant through each of the adhesive layer, the absorptive layer and the securement base.

3. The dressing of claim 1, wherein the securement base comprises a plurality of holes for receiving a lid of the enteral access device.

4. The dressing of claim 1, wherein the adhesive layer absorbs and disperses forces applied to the enteral access device.

5. The dressing of claim 4, wherein the securement base is rigid or semi-rigid.

6. The dressing of claim 4, wherein the securement base is flexible.

7. The dressing of claim 1, wherein the securement base absorbs and disperses forces applied to the enteral access device.

8. The dressing of claim 1, wherein the securement base extends to an upper level of the hub.

9. The dressing of claim 1, wherein the securement base provides three-dimensional stability to the hub of the enteral access device.

10. A dressing for securing an enteral access device, the dressing comprising:
an adhesive layer having a first surface for at least partially contacting a skin surface and a second surface opposing the first surface;
a lower base coupled to the adhesive layer, the lower base defining an opening;
an absorbent member disposed in the opening of the lower base, the absorbent member defining an aperture through which at least a portion of the enteral access device is configured to extend; and
an upper base detachably coupled to the lower base.

11. The dressing of claim 10, further comprising a lid coupled to the upper base.

12. The dressing of claim 11, wherein the lid is detachably coupled to the upper base.

13. The dressing of claim 11, wherein the lid is integrally formed with the upper base.

14. The dressing of claim 11, wherein the lid absorbs and disperses forces applied to the enteral access device.

15. The dressing of claim 10, wherein the lower base absorbs and disperses forces applied to the enteral access device.

16. The dressing of claim 10, wherein the upper base absorbs and disperses forces applied to the enteral access device.

17. The dressing of claim 10, wherein in response to the lower base and the upper base being coupled to each other, the dressing provides three-dimensional stability to the enteral access device.

18. The dressing of claim 10, further comprising a plurality of resilient gripper arms extending from an inner surface of the upper base.

19. The dressing of claim 10, wherein an engagement between the lower base and the upper base is discontinuous around the perimeter of the lower base and the upper base.

20. A method of using a dressing for securing an enteral access device, the method comprising:
attaching a lower base to an adhesive layer;
aligning an inner cutout of the adhesive layer and an opening defined by the lower base with a stoma; and
positioning an absorbent member within a shape of the lower base around the enteral access device extending from the stoma.
